(19) United States
(12) Patent Application Publication
(10) Pub. No.: US 2001/0039879 A1
(43) Pub. Date: Nov. 15, 2001

(54) Charged filter media containing charge control agents

(76) Inventor: Rick L. Chapman, Ventura, CA (US)

Correspondence Address: Marvin E. Jacobs, KOPPEL & JACOBS, Suite 215, 2151 Alessandro Drive, Ventura, CA, 93001, US

(21) Appl. No.: 09/738,052

(22) Filed: Dec. 14, 2000

Related U.S. Application Data
(60) Provisional application No. 60/172,296, filed on Dec. 16, 1999.

(51) Int. Cl. B01D 46/00

(52) U.S. Cl. 96/69; 96/226; 55/524

(57) ABSTRACT

An air filtration filter formed of material such as a resin bound fiber forming a woven or non-woven fabric, thermoplastic netting, tacifing resin solution and/or antimicrobial agents in which said material is compounded or coated to contain 0.01 to 20% by weight of a positive and/or negative charge control agent and then charging the filter to apply an electrostatic charge to the filter.

### TECHNICAL FIELD

This invention relates to electrostatic air filter media and more particular, this invention relates to air filters containing charge control agents cross-reference to related application. This application is a complete application based on provisional application No. 60/172,296, filed on Dec. 16, 1999.

### BACKGROUND OF THE INVENTION

An electrostatic charged medium is utilized in current air filtration filters. This medium is used in many different applications and in many different filters. The charge is applied to the surface of the medium such as passive electrostatic polypropylene netting used in residential air filters. The charge tends to dissipate over time leading to reduced efficiency in removing particles from air stream, particularly small particles below 10 microns.

Electrostatic type filters, having increased efficiency without increasing the amount of pressure it takes to push the air though the filter medium, are needed. Today, passive electrostatic filter medias work mainly on the principle of friction between fibers and inherent static electricity in the polymer itself. As quoted by a company which manufactures static control equipment: “Contrary to popular belief, static electrification is never caused by just an air flow hitting a solid surface.” In most cases a polypropylene honey-combed netting typically with woven monofilament approximately 0.01 inches in diameter, is used in different layers or in conjunction with a urethane foam or a high loft polyester which also has inherent static charges. In the more efficiently static charged fiber filters, each fiber has both positive and negative charges. These fibers are 1 to 30 denier in size, or approximately 0.00049 to 0.00268 inches diameter. Generally these types of filters are expensive and of a disposable type, lasting about three months. The efficiencies of these filters known as “Electret” are as previously stated, very efficient, with approximately 34% to 40% dust spot efficiency.

Charge control agents have been utilized mainly in imaging applications. Positive and negative charge control agents, charge directors, charge additives, charge adjuvants, zwitterionic materials, polar additives, dielectric substance and electroconductivity-providing agents, (ECPA's), all are referred to as CCA's and are used in the following applications: powder toner, powder coating or powder electrophotographic toner, liquid toner, liquid developer, chargeable toner, electrophotographic recording, powder paint, developing toner, electrostatic coping, electret fiber material, electrophoretic image display, impulse ink jet printing, sprayable powder coating and electrostatic image developer.

U.S. Pat. No. 4,789,504 discloses that adding salt of a fatty acid to a polymer material increases the effectiveness of polypropylene. U.S. Pat. No. 5,015,676 discloses ammonium and immonium compounds as CCA's U.S. Pat. No. 5,069,994 describes fluorinated ammonium and immonium charge control agents in polymers.

U.S. Pat. No. 5,563,016 discloses diallylammonium compounds, in particular those substituted with alkyl groups having 1-5, preferably 1 of 2 carbon atoms, in particular methyl groups and one equivalent of an anion, preferably a tetraphenylborate anion, and polymeric ammonium compounds of the formula 6 (as described in DE-A-4 029 652 or DE-A-4 103 610) in which n has a value which corresponds to molecular weights from 5,000 to 500,000. However, compounds of the formula 6 having molecular weights from 40,000 to 400,000 are particularly preferred.

U.S. Pat. No. 5,069,994 describes a method for producing toners with positive and negative charge control effects incorporating fluorinated ammonium and immonium compounds, in particular those in formula containing perfluorinated alkyl having 5-11 carbon atoms and alkyl having 1-5, preferably 1-2 carbon atoms and is one equivalent of an anion, preferably a tetraflouroborate or tetraphenylborate anion.

In DE-A-4 031 705, in particular those of the formula 7 in which R¹, R², R³ and R⁴ are identical or different alkyl groups having 1-5, preferably 2 or 3, carbon atoms and R⁵ is one of the divalent radicals —S—, —S—S—, —SO—or —SO.sub.2—. For example, R¹ to R⁴ are propyl groups and R⁵ is the group —S—S—.

In EP-A-0 258 651, the phenol derivatives are described in particular as those of the formula 8 in which R¹ and R³ are alkenyl groups having 1 to 5, preferably 1 to 3, carbon atoms and R² and R⁴ are hydrogen or alkyl having 1 to 3 carbon atoms, preferably methyl. Examples which can be mentioned are the compounds in which R¹ to R⁴ are methyl groups or in which R² and R⁴ are hydrogen and R¹ and R³ are the group —CH₂—CH²—CH₂—.

U.S. Pat. No. 5,021,473 and in U.S. Pat. No. 5,147,748 describes phosphonium compounds and fluorinated phosphonium compounds and in U.S. Pat. No. 5,147,748, in compounds of the formula 9 in which R¹, R², R³ and R⁴ are identical or different alkyl groups having 1-8, preferably 3 to 6, carbon atoms and X⁻ is one equivalent of an anion, preferably a halide anion and formula 10; in which R¹ is a highly fluorinated alkyl radical having 5-15, preferably 6-10, carbon atoms. R², R³ and R⁴ are alkyl having 3-10 carbon atoms or phenyl and X.− is one equivalent of an anion. An example of a compound of the formula 9 is tetrabutylphosphonium bromide.

As described in EP-A-0 385 580 and in EP-A-0 516 434, calyx(n)arenas, in particular those of the formula 11 in which R is hydrogen, halogen, preferably chlorine, straightchain or branched alkyl having 1-12 carbon atoms, aralkyl, e.g., benzyl or phenethyl, —NO₂,—NH₂, —NHR¹ or HR¹ R², in which R¹ is alkyl having 1-8 carbon atoms, unsubstituted or substituted phenyl or —Si(CH₃)₃.

U.S. Pat. No. 5,502,118 discloses polyester salts and their use as charge control agents whose anionic component is a polyester which comprises the product of reaction of the individual components a), b) and c) and, if desired, d) and, if desired, e), where a) is a dicarboxylic acid or a reactive derivative of a dicarboxylic acid, being free from sulfo groups, b) is a difunctional aromatic, aliphatic or cycloaliphatic sulfo compound whose functional groups are hydroxyl or carboxyl c) is an aliphatic, cycloaliphatic or aromatic diol, a polyetherdiol or a polycarbonatediol, d) is a polyfunctional compound (functionality>2) whose functional groups are hydroxyl or carboxyl, and e) is a monocarboxylic acid and whose cationic component comprises hydrogen atoms, metal cations, substituted ammonium cations, immonium cations, guanidinium cations, phosphonium, arsonium or stibonium cations or a mixture of the above-mentioned cations, are suitable as charge control agents and charge improvers in electrophotographic toners and developers, in triboelectrically or electrokinetically sprayable powder coatings, in electret materials and for the electrostatic separation of polymers and salt minerals.

U.S. Pat. No. 5,501,934 describes an enhanced chargeable resin powder wherein the host compound is a cyclic or non-cyclic compound selected from the group consisting of calyx arenas, cyclodextrins, cyclic polyethers and non-cyclic polyethers, and the guest compound is a compound selected from the group consisting of organic acids, inorganic acids, organic bases, inorganic bases and salts of these acids and bases, said charge control agent having positive chargeability where said host compound is such a calyx arene, cyclic polyether or non-cyclic polyether and having a negative chargeability where said host compound is such a cyclodextrin. The chargeable resin powder is used as a toner for developing electrostatic images and powder coating for electrostatic painting.

U.S. Pat. No. 5,693,445 discloses an electrostatic image developing toner, which comprises a binder resin, a colorant and a charge control agent, wherein the charge control agent is a hydrophobicity-imparted product of a xanthene-type dye, which is represented by the formula wherein R₁, R₃, R₅, R₆ and R₇ are independently hydrogen or a lower alkyl group, R₂ and R₄ are independently a lower alkyl group, and A is a group represented by a formula in which R₈ is a C₈₋₃₇ alkyl group, or the formula in which R₉ is a C₁₋₃₇ alkyl group, and X is O, S, NH or CH₂, and is contained in a proportion of 0.05 to 10 parts by weight per 100 parts by weight of the binder resin.

U.S. Pat. No. 5,783,346 a toner composition is disclosed which comprises a binder and a colorant, wherein said binder comprises a copolymer of a vinyl aromatic monomer; a second monomer selected from the group consisting of conjugated diene monomers or acrylate monomers selected from the group consisting of alkyl acrylate monomers and alkyl methacrylate monomers; a third monomer which is a crosslinking agent; a fourth monomer which is an adhesion-promoting vinyl monomer containing a hydroxyl group; and a fifth monomer which is a charge control vinyl monomer containing an amine group. In a preferred embodiment, the binder further comprises the acid form of an amino acid soap which is the salt of an alkyl sarcosine having an alkyl group which contains from about 10 to 20 carbon atoms. In additional preferred embodiments, the toner compositions of the invention further include a charge control agent. In other preferred embodiments, the toner compositions of the invention are used with a carrier. The toner compositions show a good combination of adhesion and charge stability.

U.S. Pat. No. 5,482,741, surface-treated charge control agent particles and method for producing the same are disclosed wherein said charge control agent comprises at least one member selected from the group consisting of 3,5-ditertbutylsalicyclic acid, potassium tetraphenylborate, potassium bis(3,5-di-tertbutylsalicylato)borate, wherein said particles comprise at least one member selected from the group consisting of silica compounds, titanium dioxide, aluminum dioxide, tin oxide and magnesium oxide, wherein said solvent comprises at least one member selected from the group consisting of cyclohexane, benzene, methanol, chloroform, heptane, ethyl acetate, hexane, methylene chloride and acetone.

U.S. Pat. No. 5,518,852 describes a negative charge control agent and toner for developing an electrostatic image containing an active ingredient consisting of an organic silicone complex compound represented by the following formula [I]: wherein R¹ and R² independently represent hydrogen; or a substituted or unsubstituted alkyl group, cycloalkyl group, aryl group or aralkyl group, R³ represents hydrogen or a substituted or unsubstituted alkyl group, cycloalkyl group, aryl group or aralkyl group, X.+ represents an inorganic or organic cation, at least one of R¹ and R² is a substituted or unsubstituted aryl group is usable in a toner for developing an electrostatic image that also contains a coloring agent and a resin.

U.S. Pat. No. 5,800,602 and U.S. Pat. No. 5,585,216, describe the use of inclusion compounds of cyclic polysaccharides as charge control agents. Cyclically linked oligo- and polysaccharides have 3 to 100 monomeric saccharide units are used as charge control agents and charging improvers in electrophotographic toners and developers, in powders and powder coatings which can be sprayed triboelectrically or electrokinetically and in electret materials.

U.S. Pat. No. 4,404,270 describes a positively chargeable powdered electrophotographic toner containing dialkyl tin oxide charge control agent selected from the group consisting of mica, monoalkyl and dialkyl tin oxides and urethane compounds, said charge control agent having high positive charging ability and good dispersibility in the resin and can be used for developing to give good quality images, having high density in the image areas and low background in the non-image areas.

In U.S. Pat. No. 4,206,064 a negatively charge control agent containing metal complex of salicyclic acid, in which the alkyl salicycle acid has an alkyl group having not more than 5 carbon atoms and the metal complex is a chromium complex, which is selected from the group consisting of nickel complexes and colbalt.

Characterized by the CAS numbers 31714-55-3, 104815-18-1, 84179-68-8, 110941-75-8, 32517-36-5, 38833-00-00, 95692-86-7, 85414-43-3, 136709-14-3, 135534-82-6, 135534-81-5, 127800-82-2, 114803-10-0, 114803-08-6 are compounds described in EP-A-0 162 632, U.S. Pat. No. 4,908,225, EP-A-0 393 479, EP-A-0 360 617, EP-A-0 291 930, EP-A-0 280 272, EP-A-0 255,925, EP-A-0 251 326, EP-A-0 180 655, EP-A-0 141,377, U.S. Pat. No. 4,939,061, U.S. Pat. No. 4,623,606, U.S. Pat. No. 4,590,141. The above listed are metal complex compounds, such as chromium azo complexes, cobalt azo complexes, iron azo complexes, zinc azo complexes or aluminum azo complexes or chromium salicylic acid complexes, cobalt salicylic acid complexes, iron salicylic acid complexes, zinc salicylic acid complexes or aluminum salicylic acid complexes of the formulae 12, 13 and 14 in which M is a divalent or trivalent metal atom, preferably chromium, cobalt, iron, zinc or aluminum. Y and Z are divalent aromatic rings, preferably of the formulae m is one of the numbers 1 or 2 and K.sup.+ is one equivalent of a cation, in which M is a divalent or trivalent metal atom, preferably chromium, cobalt, iron. R¹ is hydrogen, halogen, preferably Cl, nitro or amidosulfonyl, R² is hydrogen or nitro, R³ is hydrogen, the sulfonic acid group, —CO—NH—R⁴, in which R⁴=phenyl, alkyl having 1-5 carbon atoms, which can be unsubstituted or substituted by a mono-, di- or trialkylamino group and Z is a counter ion which produces the neutrality of the complex, preferably a proton, an alkali metal ion or an ammonium ion in which M is a divalent metal central atom, preferably a zinc atom, R¹ and R² are identical or different, straight-chain or branched alkyl groups having 1-8, preferably 3-6, carbon atoms, for example, tert-butyl.

As described in EP-A-0 347 695, benzimidazolones, in particular those of the formula in which R¹ is alkyl having 1-5 carbon atoms and R² is alkyl having 1-12 carbon atoms and X is one equivalent of an anion, in particular a chloride or tetrafluoroborate anion (an example which can be mentioned is the compound having R¹, CH₃ and R² C₁₁ CH₂₃), or azines of the following Color Index number: C.I. Solvent Black 5, 5:1, 5:2, 7, 31 and 50; C.I. pigment Black 1, C.I. Basic Red 2 and C.I. Basic Black 1 and 2.

U.S. Pat. No. 5,318,883 Charge control agent whose active agent is a calix(n) compound represented by formula [I]: wherein R¹ represents an alicyclic group; R² represents a hydrogen atom, an alkyl group having 1 to 4 carbon atoms or an aryl group; and n represents an integer of 1 to 8, is provided, which can be incorporated into a toner for developing electrostatic images.

U.S. Pat. No. 5,612,161 the charge control agent comprising a copoymer of 1 to 30% by weight of a sulfoalkyl (meth) acrylic acid monomer represented by a specific chemical formula and 99 to 70% by weight of other copolymerizable vinyl monomer. A toner with good stable properties under the conditions of high temperatures and high humidities is disclosed.

U.S. Pat. No. 5,681,680 discloses difunctional N-(2-cyanoethanyl) sulfonamides and toner compositions containing them are disclosed. The described charge control agents are negative charge control agents and are essentially colorless making them particularly useful in toner compositions for color electrophotography.

U.S. Pat. No. 5,061,585 discloses a blue coloring agent for electro-photographic copying processes with positive control effect for electrophotographic copying processes is disclosed.

U.S. Pat. No. 4,840, 864 discloses new electrostatographic toners and developers are provided containg new charge-control agents comprising quaternary ammonium salts of the given formula wherein R is alkyl having 12 to 18 carbon atoms.

U.S. Pat. No. 5,192,637 discloses an electrophotographic toner composition comprising a toner particle and an additive is disclosed, the toner particle comprising at least a binder resin and a colorant, and the additive being amorphous titania fine particles subjected to a surface treatment using a coupling agent.

U.S. Pat. No. 4,833,060 discloses polymeric powders having a predetermined and controlled size and size distribution are prepared by dissolving a polymer in a solvent which is immiscible with water forming a suspension of small droplets of the polymer and solvent in water containing a promoter and silica particles, removing the solvent from the droplets and separating the solidified particles from the water.

U.S. Pat. No. 4,394,430 discloses electrophotographic dry toner and developer compositions alkyldimethylbenzylammonium salts are employed as charge control agents for fusible dry electrophotographic toners.

U.S. Pat. No. 5,935,754 discloses preparation of liquid toners containing charge directors and components for stabilizing their electrical properties and a method for producing liquid toner compositions containing charge directors and in which the electrical properties of the charge directors are stabilized, which method comprises the steps of: (A) first making a homogenous liquid composition which comprises (1) liquid hydrocarbon compatible with liquid toners for electrostatic imaging, (2) at least one charge director, and (3) at least one stabilizing component in an amount effective to stabilize the electrical properties of at least one charge director, the stabilizing component being selected from soluizible acids which include organic moieties (e.g. C₁₂ to C₁₈ saturated aliphatic carboxylic acids, C₄ to C₁₈ ethylenically unsaturated aliphatic carboxylic acids, C₇ to C₁₃ aromatic carboxylic acids, and partial alkyl esters of orthophosphoric acid containing 12 to 36 carbon atoms); and (B) mixing the homogeneous liquid composition from step (A) in any order with at least component (5) from the following components (5) and (6), namely, (5) pigmented thermoplastic resin particles, and (6) further liquid hydrocarbon as defined in (1), above, such that component (5) is micro-dispersed in the toner composition. A charge director is selected from the group consisting of lecithin, basic barium petronate and calcium petronate.

U.S. Pat. No. 5,952,145 discloses calix arene charge control agent and toner for developing electrostatic images comprising such a charge control agent whose active ingredient is a calyx (n) arene compound of formula I: wherein x+y=n; x and y each is an integer of 1 or more; n is an integer of 4-8; the x repeat units and y repeat units can be arranged in any order; R¹ and R² each is H, C₁₋₁₂ alkyl, C₂₋₁₂ alkenyl, C₇₋₁₂ aralkyl, phenyl, C₄₋₈ cycloalkyl, halogen, nitor, amino, alkyl- or phenyl-substituted amino, —Si((CH₃)₃, or —SO₃ H; and of the n R radicals in the—OR groups, 1 to (n-1) are H, with remaining (n-1) to 1 being alkyl, alkenyl, phenyl, aralkyl, cycloalkyl, —COR³ >wherein R³ is H, alkyl, alkenyl, phenyl, aralkyl, or cycloalkyl, —Si(CH₃)₃, —(CH₂)m COOR₄>wherein R₄ is H or lower alkyl and m is an integer of 1-3, —(CH₂ CH₂)r H>wherein r is an integer of 1-10.

U.S. Pat. No. 5,750,306 discloses graft copolymers and colorless, transparent electrophotographic toners comprising of recurring units of (C₆-C₁₈)alkyl (meth)acrylate (A), N-vinylpyrrolidone (B), glycidyl (meth)acrylate (C), and glycidyl (meth)acrylate units esterified with (meth)acrylic acid (D) onto which polymeric side chains of units of N-vinylpyrrolidone, (C₁-C₃) alkyl acrylate and, if appropriate, (C₁-C₃) alkyl methacrylate are grafted. The polymer is suitable as a binder for colorless, negatively chargeable liquid toners, in particular in combination with graft copolymers of (C₁-C₆)alky (meth)acrylate, (C₆-C₁₈) alkyl (meth)acrylate and its units in which chains of N-vinyl-pyrrolidone untis are grafted onto one of the untis mentioned, as a charge control agent. After fixing of the electrophotographically produced toner image, the toners give colorless resist masks or printing screens with a high resistance toward etching agents and solvents.

U.S. Pat. No. 5,714,296 discloses graft copolymers and colorless, transparent electrophotographic toners thereof recurring units of (C₆-C₁₈)alkyl (meth)acrylate (A), vinylpyridine (B), glycidyl (meth) acrylate (C), and glycidyl (meth) acrylate units esterified with (meth)acylic acid (D) onto which polymeric side chains of units of vinypyridine, (C₁-C₃)alkyl acrylate, and optionally (C₁-C₃)alkyl methacrylate are grafted. The polymer is suitable as a binder for colorless, positively chargeable liquid toners, in particular in combination with a coplymer of (C₆-C₁₈)alkyl (meth) acrylate and hydroxyalkyl (meth)acrylate as charge control agents. After fixing of the electrophotographically produced toner image, the toners give colorless resist masks or printing screens with a high resistance toward etching agents and solvents.

U.S. Pat. No. 5,525,450 discloses liquid developer compostions with multiple block copolymers comprised of a nonpolar liquid, thermoplastic resin particles, a charge adjuvant, pigment, and a charge director selected from the group consisting of the triblock polymers BAA′, BA′A, and ABA′ wherein A, A′ and B represent polymer segments or blocks, the polar A block repeat unit contain an alkylated or protonated ammonium charged site and the A′ block repeat units contain an acid group of a pKa equal to or less than about 7.0, and wherein the nonpolar B block repeat units contain aliphatic hydrocarbon solubilizing groups; and wherein the A and A′ block number average molecular weights range from about 200 to 120,000, and the B block number average molecular weights range from about 2,000 to 190,000; and the total number average molecular weight of said charge director is from about 2,400 to about 300,000, and the ratio of M_{w} to Mₙ for said charge director is 1 to 5.

U.S. Pat. No. 5,525,448 discloses Liquid developer compositions with quaternized polyamines comprised of thermoplastic resin particles, pigment, a charge director, and an insoluble charge adjuvant comprised of a polymeric quaternary ammonium compound, and wherein the charge adjuvant is associated with or combined with said resin and said pigment.

U.S. Pat. No. 4,707,429 discloses liquid developers with an aluminum stearate charge adjuvant. Liquid developers with certain charge directors are illustrated in U.S. Pat. No. 5,045,425. Also, stain elimination in consecutive colored liquid toners is illustrated in U.S. Pat. No. 5,069,995. Additionally, of interest are U.S. Pat. Nos. 4,760,009; 5,034,299 and 5,028,508.

U.S. Pat. No. 5,573,882 discloses liquid developer compositions with charge director block copolymers a negatively charged liquid developer comprised of a nonpolar liquid, thermoplastic resin particles, pigment, a charge adjuvant, and a BAB polymer charge director wherein A and B represent the polar and nonpolar polymer segments, respectively.

U.S. Pat. No. 5,019,477, the disclosure of which is expressly incorporated herein by reference, discloses a liquid electrostatic developer comprising a nonpolar liquid, thermoplastic resin particles, and a charge director. The ionic or zwitterionic charge directors may include both negative charge directors, such as lecithin, oil-soluble petroleum sulfonate and alkyl succinimide, and positive charge directors such as cobalt and iron naphthenates. The thermoplastic resin particles can comprise a mixture of (1) a polyethelene homopolymer or a copolymer of (i) polyethylene and (ii) acrylic acid, methacrylic acid or alkyl esters thereof, wherein (ii) comprises 0.1 to 20 weight percent of the copolymer; and (2) a random copolymer of (iii) selected from the group consisting of vinyl toluene and styrene, and (iv) selected from the group consisting of butadiene and acrylate.

U.S. Pat. No. 5,030,535 discloses a liquid developer composition comprising a liquid vehicle, a charge control additive and toner particles. The toner particles may contain pigment particles and a resin selected from the group consisting of polyolefins, halogenated polyolefins and mixtures thereof. The liquid developers are prepared by first dissolving the polymer resin in a liquid vehicle by heating at temperatures of from about 80 degree. C. to about 120 degree. C., adding pigment to the hot polymer solution and attriting the mixture, and then cooling the mixture so that the polymer becomes insoluble in the liquid vehicle, thus forming an insoluble resin layer around the pigment particles, may be selected from known thermoplastics, including fluoropolymers.

In U.S. Pat. No. 5,026,621 discloses a toner for electrophotography which comprises as main components a coloring component and a binder resin which is a block copolymer comprising a functional segment (A) consisting of at least one of a fluoroalkylacryl ester block unit or a fluoralkyl methacryl ester block unit, and a compatible segment (B) consisting of a fluorine-free vinyl or olefin monomer block unit. The functional segment of block copolymer is oriented to the surface of the block polymer, and the compatible segment thereof is oriented to be compatible with other resins and a coloring agent contained in the toner whereby the toner is provided with both liquid repelling and solvent soluble properties.

U.S. Pat. No. 5,364,729, the disclosure of which is expressly incorporated herein illustrates a process for forming images which comprises (a) generating an electrostatic latent image; (b) contacting the latent image with a developer comprising a colorant and substantial amount of a vehicle with a melting point of at least about 25.degree. C., which developer has a melting point of at least about 25.degree. C., the contact occurring while the developer is maintained at a temperature at or above its melting point, the developer having a viscosity of no more than about 500 centipose and a resistivity of no less than about 10₈ ohm-cm at the temperature maintained while the developer is in contact with the latent image; and (c) cooling the developed image to a temperature below its melting point subsequent to development.

U.S. Pat. No. 5,407,775, the disclosure of which expressly incorporated herein by reference, illustrates a liquid developer comprised of a liquid, thermoplastic resin particles, a nonpolar liquid soluble charge director comprised of a zwitterionic quaternary ammonium block copolymer wherein both cationic and anionic sties contained therein are covalently bonded within the same polar repeat unit in the quaternary ammonium block copolymer.

U.S. Pat. No. 5,549,007, the disclosure of which is expressly incorporated herein by reference, illustrates a liquid developer comprised of a liquid, thermoplastic resin particles, a nonpolar liquid soluble charge director comprised of an ionic or zwitterionic quaternary ammonium block copolymer ammonium block copolymer, and wherein the number average molecular weight thereof of said charge director is from about 70,000 to about 200,000.

U.S. Pat. No. 5,484,679, the disclosure of which is expressly incorporated herein by reference, illustrates liquid developers containing block polymer negative charge directors comprised of a total of at least three blocks, ammonium A blocks and nonpolar B blocks in various combinations, and more specifically, triblock copolymers of the formula A-B-A wherein the polar A block is an ammonium containing segment and B is a nonpolar block segment which, for example, provides for charge director solubility in the liquid ink fluid like ISOPAR.TM., and wherein the A blocks have a number average molecular weight range of rom about 200 to about 120,000; the B blocks have a number average molecular weight range of from about 2,000 to 190,000; the ratio of M_{w} to Mₙ is 1 to 5; and the total number average molecular weight of the ABA copolymer is, for example, from about 6,200 to about 300,000, and preferably about 200,000.

U.S. Pat. No. 5,409,796 discloses a positively charged liquid developer comprised of thermoplastic resin particles, optional pigment, a charge director, and a charge adjuvant comprised of a polymer of an alkene and unsaturated acid derivative; and wherein the acid derivative contains pendant ammonium groups, and wherein the charge adjuvant is associated with or combined with said resin and said optional pigment.

U.S. Pat. No. 5,411,834 discloses a negatively charged liquid developer comprised of thermoplastic resin particles, optional pigment, a charge director, and an insoluble charge adjuvant comprised of a copolymer of an alkene and an unsaturated acid derivative, and wherein the acid derivative contains pendant fluorlalkyl or pendant fluoroaryl groups, and wherein the charge adjuvant is associated with or combined with said resin and said optional pigment.

U.S. Pat. No. 5,484,679 discloses negatively-charged liquid developer compositions comprised of a nonpolar liquid with multiple block copolymers, thermoplastic resin particles, a charge adjuvant, pigment, and an ABA polymer charge director wherein A and B represent the polymer segments.

U.S. Pat. No. 5,308,731 discloses a liquid developer comprised of a liquid, thermoplastic resin particles, a nonpolar liquid soluble charge director, and a charge adjuvant comprised of a metal hydroxycarboxylic acid.

U.S. Pat. No. 5,476,743, discloses a liquid developer compositions with organic additives comprised of a nonpolar liquid, thermoplastic resin particles, polar organic additives with a dielectric constant in the range of about 20 to about 150, and soluble in the nonpolar liquid; and charge director.

U.S. Pat. No. 5,445,911 discloses a chelating positive charge director for liquid electrographic toners. The charge director comprises a very strongly chelating functional group covalently bonded in the resin coating or pigment component, or an intrinsic part of the pigment component, of the toner particle, and a very weakly associated, preferably ionic, molecule dispersed in the liquid phase to achieve charge separation. The strong chelation site on the resin is prepared, via well-known polymer chemistry. For the ionic molecule, preferred cations are those with no regulatory, health or environmental issues, such as K⁺, Na⁺, Ca²⁺, Al³⁺, Zn²⁺, Zr⁴⁺, Mg²⁺, ammonium (NH₄₊), and organic cations. The chelate-containing resin is brought into dispersion with the liquid phase containing the ionic molecule. When this is done, the equilibria that compete for the cation are such that it is released from the ionic molecule and bound in the chelate. The toner particle is left with a net positive charge which is permanent, but which is balanced by an equal, opposite charge on the counter anionic species in the continuous phase. Preferably, there are no other sources of charge in the dispersion, and there is the no excess of charge carriers in the continuous phase which would interfere with development.

U.S. Pat. No. 5,045,425 (Swidler) teaches incorporation of salicylates in a resin, and addition of Al³+ complexes of salicylates to the dispersion. In this case, the formation constant of the Al³+ complex with the surface salicylate groups is high, and if the total concentration of the aluminum is optimized, most of it is bound to the surface of the toner particle.

U.S. Pat. No. 5,411,834 discloses negatively charged liquid developer compositions with fluoroalkyl groups comprised of thermoplastic resin particles, optional pigment, a charge director, and an insoluble charge adjuvant comprised of a copolymer of an alkene and an unsaturated acid derivative, and wherein the acid derivative contains pendant fluoroalkyl or pendant fluoroaryl groups, and wherein the charge adjuvant is associated with or combined with said resin and said option pigment.

U.S. Pat. No. 5,035,972, the disclosure of which is expressly incorporated herein by reference, there are illustrated liquid developers with quaternized ammonium AB diblock copolymer charge directors, and wherein the nitrogen in the ionic A block is quaternized with an alkylating agent.

U.S. Pat Nos. 5,306,591 and 5,308,731 are examples of adjuvants, the disclosures of which are totally incorporated herein by reference.

U.S. Pat No. 5,407,774 discloses a charge control agent for positive charging whose active ingredient is a salt-forming compound represented by the following formula and a positively chargeable toner for developing electrostatic images comprising at least one kind of the charge control agent, a coloring agent and a resin.

U.S. Pat. No. 5,346,796 discloses electrically stabilized liquid toners, of a homogeneous liquid composition, for use in the preparation of liquid toners containing at least one charge director and in which the electrical properties of the charge director(s) is/are stabilized, comprises: (1) insulating non-polar carrier liquid compatible with liquid toners for electrostatic imaging; (2) at least one charge director other than an amine salt; and (3) at least one stabilizing component in an amount effective to stabilize the electrical properties of said at least one charge director, said component being selected from non-quaternary amine salts and being soluble in the carrier, e.g. diethylammonium chloride and isopropylamine dodecylbenzenesulfonate. The invention further relates to liquid toners for electrostatic imaging comprise thermoplastic resin particles dispersed in an insulating nonpolar carrier liquid, preferably a hydrocarbon having a volume resistivity about 10⁰ ohm-cm and a dielectric constant below 3.0, colorant particles micro-dispersed in said carrier liquid, at least one charge director, and at least one stabilizing component (3), as defined above; a method for producing the liquid toners; and an electrostatic imaging process utilizing the liquid toners.

U.S. Pat. No. 5,393,635 discloses a chelating negative charge director for liquid electrographic toners. The charge director comprises a very weakly associating, charged functional group covalently bonded in the resin coating of the toner particle, and a very strongly chelating, preferably neutrally charged, molecule dispersed in the liquid phase to achieve charge separation. The weak association site on the resin is prepared, via well-known ion-exchange chemistry, in the metal form desired. Preferred metals are those with no regulatory, health or environmental issues, such as K⁺, Na⁺, Ca²⁺, Al³⁺, Zn²⁺, Zr⁴⁺, Mg²⁺, ammonium (NH₄₊), and organic cations. The cation-associated resin is brought into dispersion with the solution phase chelating molecule. When this is done, the equilibria that compete for the cation are such that it is released from the resin and bound in the chelate. The toner particle is left with a net negative charge which is permanent, but which is balanced by an equal, opposite charge on the chelated cationic species in the continuous phase. Preferably, there are no other sources of charge in the dispersion, and there is no excess of charge carriers in the continuous phase which would interfere with development.

U.S. Pat. No. 4,924,766 (Elmasry, et al.), incidentally discloses possible use of oligomers containing amine groups as charge directors.

Two U.S. Patents of Kosel (U.S. Pat. Nos. 3,753,760 and 3,991,226) list many components of liquid toners, including charge directors. The isopropylamine salt of dodecylbenzenesulfonic acid is one of many charge directors disclosed in these two patents. The present inventors have found, however, that this salt is a poor charge director. This finding is not entirely surprising, because the utility of an amine as charge director is believed to depend on its ability to form salts with the polycarboxylic resin particles, from which cations may be split off leaving a charged residue, amine salts could, thus, not readily perform this function.

U.S. Pat. No. 4,977,056 (El-Sayed) discloses use of an alkylhydroxybenzylpolyamine as an adjuvant in liquid toners, in addition to a charge director, while in U.S. Pat. No. 4,783,388 (El Sayed, et al.) there are disclosed liquid toners containing charge directors and an additional component which is a quaternary ammonium hydroxide. There is no suggestion in either patent that the additive stabilizes the electrical stability of the toners.

U.S. Pat. No. 5,266,435 discloses liquid toners containing charge directors and components for stabilizing their electrical properties. The invention relates to a homogeneous liquid composition which comprises: (1) liquid hydrocarbon compatible with liquid toners for electrostatic imaging, (2) at least one charge director, and (3) at least one stabilizing component in an amount effective to stabilize the electrical properties of said at least one charge director, said component being selected from piperidinemethanol and polyoxyalkylene ethers of formula R(O—A)ₙ. OH, where R is alkyl or alkenyl containing 10-20 carbon atoms, A is C₂₋₃-alkylene and n is 2-24; and to liquid toners characterized by the presence of at least one charge director and at least one stabilizing component therefore as defined in (3), above.

U.S. Pat. No. 5,051,330 discloses fluorinated onium salts as toner electrostatic transfer agents and charge control agents are provided for increasing the electrostatic transfer efficiency of toner powder from an element to a receiver sheet. The method involves conducting such transfer in the presence of at least one fluorinated onium salt wherein either one or both of the cationic portion and the anionic portion thereof contain a fluorinated hydrocarbon group. Further included are novel toner powders, a novel coated element, and certain new fluorinated onium salt compounds.

U.S. Pat. No. 5,411,576, discloses an oily mist resistant electret filter media. The filter media includes polypropylene electret fibers and a melt processable fluorochemical additive. The additive has a melt temperature of at least 25 degrees C. and a molecular weight of about 500 to 2500. Also provided is a method for filtering particulate material from air containing oily aerosol particles.

U.S. Pat. No. 5,645,627 discloses an electret filter media which includes an additive or mixtures thereof that enhance the charge stability of the media. The filter media achieves acceptable alpha values for a range of filtration challenges without significant decay in alpha values over time. Preferred charge additives include fatty acid amides, oleophobic fluorochemical surfactants, and mixtures thereof.

U.S. Pat. No. 4,496,643, discloses a two-component, dry electrostatic developer composition containing toner particles and coated-carrier particles is disclosed. The toner contains a binder polymer and a phosphonium, arsonium or stibonium charge-control agent dispersed in the toner binder. The carrier is coated with a fluoropolymer. The resulting developer exhibits reduced toner throw-off and other disclosed advantages.

All of the above prior references are incorporated by reference.

### STATEMENT OF THE INVENTION

This invention provides several different advancements of media manufacturing and chargeability of these mediums, increases efficiencies based on electrostatic technology, as well as provide several different ways of media and methods of enhancing the medium charge and efficiency. The novel modified materials produced by doping polymers and the induction off these polymers of an electrostatic field will result in increased air filtration efficiencies.

In the invention, permanent charge is provided in air filter media by compounding or doping charge control agents into the media or coating surfaces of filters or fabric or materials utilized in the media with charge control agents.

This invention provides a novel method of doping adhesive binder resins, antimicrobial agents, tackifier, surface coating, and netting with charge control agents used. Some doping can occur before the agents are processed in a form that will be used in the final manufacturing of the mediums which may be affected by the doping process. The object of this invention is to induce a charge field not only on the surface of the adhesive binder, but to provide an electrostatic charge below the surface of the non-conductive adhesive binder being used by compounding or dispersing the agent throughout the bulk of the media material. This method of enhancing the charges can be utilized in most of the mediums used today. Some of the polymer fibers suitable for chemical adhesive bonding, or coating, and charging are polypropylene, polyesters, polyethylene, polycarbonates, polyacrylates, polyacrylonitriles, polystyrenes or fluorinated polymers, polytetrafluoroethylene, perfluorinated ethylene, propylene, polyimides, polyether ketones, cellulose ester, nylon and polyamides. Most synthetic fibers can be mixed together or combined with organic fibers. This invention adds 0.1 to 50 percent of the charge control agents by weight of materials to polymer adhesive binders, and some non-polymer, adhesive binders such as, polymethacrylic, polysulfonates, acrylic, styrenated acrylics, vinyl acetate, vinyl acrylic, ethylene vinyl acetate, stryrene-butadiene, polyvinyl chloride, ethylene/vinyl chloride, vinyl acetate copolymer, latex, polyester copolymer, carboxylated styrene acrylic or vinyl acetate, epoxy, starch, styrene, acrylic multipolymer, phenolic, polyurethane and other adhesive binders individually stable or in combination with each other. The agents utilized are sufficiently thermally stable to survive the adhesive bonding application process or any similar process.

Charge Control Modifiers:

I. Preferred Charge Control Agents (CCA's)

The charge control agents operate by triboelectric charging of particles. In general, optimum concentrations of particles are 0.5-65% by weight and effects are superior when CCA's are uniformly dispersed in the adhesive.

A. A lecithin derivative—LECIGRAN MT results in a (+) charge if the contact is a conductor and a (−) charge if the contact is resistive. A recommended polymer is a styrene-methymethacrylate copolymer. Since this material would be close to the middle of the triboelectric series, it appears that the lecithin merely enhances the ability of the material to either donate or accept electrons depending on the resistivity of the other half of the triboelectric couple. Lecithin and other derivatives are commonly available chemicals.

B. Nigrosine and its derivatives are unusual in that they tend to result in negative polarity charging at low concentrations. They also are readily available commercially.

C. Fumed silica can be hydrophilic or hydrophobic. In the former state it imparts high negative charges to copolymers such as styrene-butylmethacrylate. Even higher negative charges would be expected in polyethylene and polypropylene because of their more negative position in the triboelectric series. Moderate relative humidity variations should not affect the electrostatic charge significantly. Cabot Corporation is one of the principal manufacturers of fumed silica and other silicas.

D. There is an increasingly popular theory that triboelectric charging is due to the transfer of ions from one surface to another. Materials like polyacrylic and polymethacrylic acids, poly (styrene-co-vinylpyridinium toluene sulfonate), methyl or butyl triphenyl phosphonium-p-toluene sulfonate (Eastman Chemical), complex aromatic amines, some quaternary ammonium salts, triphenylamine dyes and azine dyes are all charge control agents. It has been shown that when the bulkiest part of the CCA molecule or polymer is a cation, the resulting triboelectric charge is (+) Conversely, when the bulkiest part of the CCA material is an anion the triboelectric charge is (−). The small counterion transfers to the other triboelectric material producing the opposite polarity charge. Therefore acids, complex amines, several dyes, and quarterary ammonium salts charge positively; while sulfonates, whether polymers or not, and similar compounds charge negatively. Hodogaya Chemical Company, LTD produced materials used specifically to control charge magnitude and polarity. Several other chemical companies make materials that can serve the same purpose.

E. Slightly conductive particles at low enough concentrations insulate materials so there is little or no particle to full particle contact can acquire high triboelectric charges. Carbon blacks are a good example. One variety is an oxidized acidic carbon black, which tends to acquire a negative charge. Unoxidized carbon black, on the other hand, when dispersed in the same polymer, acquires a positive charge. Thus, it may be possible to use only one plastic micro-fiber and control charge polarity with different CCAs. Such an approach could lead to substantial material production and processing cost savings.

F. Hodogaya Chemical Company, LTD appears to have a rather substantial research program on innocuous CCA materials. This company reports that benzoic acid derivations are effective charge control agents. Para-trifluoro methyl benzoic acid produces very high (+) charges but ortho-fluoro benzoic acid yields the highest (−) charges.

Test 1

Formula A was standard acrylic adhesive binder doped with 10 percent fumed silica. The binder solution was mixed with water, and then saturate ion bonded with 6 and 15 denier fibers 2.5 ounces/sq.yd, resulting in materials dried. The material was charged with a cold charging apparatus to approximately 1,000 volts. 10 days after the charge, the charge state of 1,000 volts positive charge was maintained, this charge was tested with a Chapman Corporation Volt Meter.

Formula B consisting of a media identical to the media of Formula A expect that it utilizes undoped acrylic adhesive binder. Fractional efficiency testing was conducted at 140 feet/minute media velocity.

Efficiency Percentages

| Micron | Doped and Charged Media | Undoped and Uncharged Media |
|---|---|---|
| Size | Formula A | Formula B |
| .3 | 3.7 | 2.6 |
| .5 | 12.2 | 10.3 |
| .7 | 21.0 | 18.1 |
| 1.0 | 26.2 | 25.4 |
| 2.0 | 46.3 | 41.0 |
| 5.0 | 80.3 | 75.0 |
| 10.0 | 87.5 | 84.2 |

### Results

Even at the high velocity of 140 ft./minute and the small percentage of charge control agent, positive increase in efficiencies were achieved demonstrating the improved effect in charging and doping the adhesive binder. Laser efficiency testing at lower air flows and higher concentrations of charge control agents will show a higher potential to capture smaller micron particles.

Test 2

Formula A was standard acrylic adhesive binder doped with 2 percent polyacrylic acid. Such a binder solution was mixed with water, and then saturate ion bonded with 6 and 15 denier fibers 2.5 ounces/sq.yd, resulting in materials dried. This material was charged to approximately 1,000 volts. After 32 days the charge was measured resulting in 1,000 volts positive charge. These measurements were tested with a Chapman Corporation Volt Meter.

Formula B consisted of a media identical to Formula A except that undoped acrylic adhesive binder was utilized. Fractional efficiency testing was conducted at 10.5 feet/minute media velocity.

Efficiency Percentages

| Micron | Doped and Charged Media | Undoped and Uncharged Media |
|---|---|---|
| Size | Formula A | Formula B |
| .3 | 0.8 | 0.1 |
| .5 | 2.0 | 0.6 |
| .7 | 9.5 | 0.9 |
| 1.0 | 26.0 | 12.0 |
| 2.0 | 44.0 | 15.5 |
| 5.0 | 57.5 | 26.6 |
| 10.0 | 82.5 | 77.1 |

### Results

With only 2 percent (a small percentage) of charge control agent, positive increases in efficiencies were achieved again demonstrating the improved effect from charging and doping the binder. Considerable change in efficiency is seen between 0.7 micron up to 10 micron.

Test 3

Formula A was standard acrylic adhesive binder doped with 5 percent polyacrylic acid. The binder solution was mixed with water, and then spray bonded “lofty” with 6 and 15 denier fibers 4.0 ounces/sq.yd, resulting in materials dried. This material was charged with the cold charging method of Test 1 and charged to approximately 1,000 volts. After 120 days, voltage measurements were recorded resulting in 1,000 to 2,000 volts positive charge tested with a Chapman Corporation Volt Meter.

Formula B consisting of a media containing undoped acrylic adhesive binder. Fractional efficiency testing was conducted at 10.5 feet/minute media velocity.

Efficiency Percentages

| Micron | Doped and Charged Media | Undoped and Uncharged Media |
|---|---|---|
| Size | Formula A | Formula B |
| .3 | 1.4 | 1.2 |
| .5 | 3.2 | 3.0 |
| .7 | 8.0 | 5.0 |
| 1.0 | 12.0 | 6.0 |
| 2.0 | 25.0 | 11.0 |
| 5.0 | 50.0 | 29.3 |
| 10.0 | 84.1 | 73.2 |

Test 4

Formula A was a polypropylene netting doped with 5% fumed silica and charged by the cold charging method of Test 1.

Formula B is standard polypropylene netting, same as above without any doping.

Efficiency Percentages

| Micron | Doped and Charged netting | Undoped and Uncharged netting |
|---|---|---|
| Size | Formula A | Formula B |
| .3 | 0.01 | 0.0 |
| .5 | 0.03 | 0.0 |
| .7 | 0.04 | 0.0 |
| 1.0 | 0.09 | 0.0 |
| 2.0 | 2.3 | 0.5 |
| 5.0 | 9.0 | 2.0 |
| 10.0 | 21.6 | 11.3 |

### Results

With 5 percent charge control agent, positive efficiencies were achieved demonstrating the improved effect by charging and doping the netting. Considerable improvement in efficiency is seen between 0.7 micron up to 10 micron.

The adhesive base binder can be selected from acrylic adhesive compounds, latex adhesive compounds, epoxy adhesive compounds and other organic or inorganic adhesive compounds, preferably contains, as charge control compounds, one or more of the various compounds. Charge control agents of one or more of the various compounds doped or grafted the polymers used in the extruding or woven netting and of netting used in filtration.

The charge control agents or charge enhancers host guest as an essential component is a complex compound resulting from incorporation of a guest compound by a host compound, by a weak interaction such as hydrogen bonding, and also referred to as an inclusion compound or host-guest complex. The guest-host compound is incorporated in the thermosetting resin or thermoplastic resin as a binder resin for an adhesive, whereby the charge of the adhesive binder resin powder is controlled or enhanced.

In general, with respect to charge control agents or charge enhancers having the salt structure [A]⁺ [B]⁻, such as quaternary ammonium salts and polyester salts, the charging polarity is empirically known to depend on the molecular weights of A and B. Specifically, a positive charge occurs when A has a higher molecular weight; a negative charge occurs when B has a higher molecular weight. This has been confirmed by the relationship between the cationic component weight ratio and the amount of charges in quaternary ammonium and polyester salt type charge control agents or charge enhancers having the [R₂NR′₂]⁺ X⁻ type structure (the amount of positive charges increases as the weight ratio of cationic components increase) [Anzai et al., 35^{th} Joint seminar of the Society of Electrophotography of Japan and the Institute of Electrostatics Japan, 1990].

The action of the host-guest compound can be explained on the basis of the above empirical rule as follows: As expected from the above empirical rule metal salts such as KF and KBr and ammonium salts having a lower alkyl group, such as tetramethylammonium halides, show almost no chargeability. However, when they are incorporated in host compounds as exemplified in the present invention to yield host-guest compounds, they show increased amounts of charges as a result of an increase in the molecular weight of the cationic or anionic moiety thereof. Improved compatibility with the binder resin resulting from the formation of the guest-host compound is also contributory to the increased and stabilized amount of charges. Example host compounds for producing host-guest compounds in the present invention include the following: calyx arenas, cyclodextrins, cyclic polyethers and non-cyclic polyethers.

Cold Charging:

It is essential that the electrical field and currents emanating from the generated source be high enough to drive the charges below the surface of the material. Another very important parameter is time during which the fibers are in the electrical field. Since molecular and charge mobility in high molecular weight solids is low, there must be sufficient time for the molecules to rotate and charges to migrate, e.g. 1 to 10 seconds and perhaps longer. Low productivity can be avoided by using a series of charging units so that the material is in the presence of the electrical field long enough. Low productivity reduction can be avoided by using a series of charging units so that the material is in the presence of the electrical field long enough.

In this invention it will be demonstrated that it is possible to charge fibrous structures and nettings and such using conductive rubber rolls. Voltages required are lower than for standard corona units and, such arrangements are easier to use when multiple passes are desired. The charging station will consist of 2 or more rollers covered with a conductive rubber so that the charge emitted can fully penetrate the doped polymers. Voltage generated for each station can range from 1 to 30 kilovolts. Each station may be charging positive or negative or a mixture of both. The number of charging stations necessary will be determined by the speed of the materials being charged. Also the voltage will change accordingly to the speed of materials being charged.

Other methods of charging could include initially passed across a corona discharge which impacts positive and negative charges on opposite sides of the materials. In another method, a charge is released between fine wires and a surface electrodes.

It is to be realized only preferred embodiments of this invention have been described, and that numerous substitutions, modifications, alterations, and applications are permissible without departing from the spirit and scope of the invention as defined in the following claims.

1. An air filtration filter having enhanced electrostatic charge comprising a material utilized in the filter being compounded with a charge control agent.

2. An air filtration media according to claim 1 in which the material is selected from the group consistency of adhesives resin binders for fibrous antimicrobial agents, tachifiei resins for woven or non-woven filtration media and thermoplastic nettings.

3. An air filtration media according to claim 1 in which the charge control agent is present on the surface of the material

4. An air filtration media according to claim 1 in which the charge control agent is dispersed within the material.

5. An air filtration filter according to claim 1 in which the charge control agent contains a positive and/or negative charge.

6. An air filtration filter according to claim 2 in which the adhesive resin binder is selected from the group consisting of polymethacrylic, polysolfonates, acrylic, styrenated acrylics, vinyl acetate, vinyl acrylic, ethylene vinyl acetate, stryrene-butadiene, polyvinyl chloride, PVA, ethylene/vinyl chloride, vinyl acetate copolymer, latex, polyester copolymer, carboxylated styrene acrylic or vinyl acetate, epoxy, starch, styrene, acrylic multipolymer, phenolic, polyurethane latex, polyester copolymers, epoxy, starch, styrene-acrylic, phenolic and polyurethane resins.

7. A air filtration filter according to claim 2 in which the netting is a woven or extruded polypropylene, polyester, polystyrene, nylon, low density polyethylene (LDPE), high density polyethylene (HDPE), (LLDPE), (EVA), radiation resistant PP, polyethylene terephtalate (PE), polysolfonate, and polyvinyl chloride (PVC).

8. An air filtration filter according to claim 1 in which the charge control agent is applied to the surface of the material by a solvent or water based charge control solution that is sprayed on a mechanically bonded fibrous filtration media.

9. An air filtration filter according to claim 1, in which the charge control agents are selected from the group consisting of compounds of organic or organometallic charge control compounds, polymer salt compounds, inclusion compounds of cyclic polysaccharides, triphenylmethanes compound, azochromium complex compound, ammonium and immonium compounds, fluorinated ammonium and immonium compounds, biscationic amides, polymeric ammonium compounds, diallylammonium compounds, arylsulfide derivative compounds, phenol derivatives, phosphonium compounds and fluorinated phosphonium compounds, calyx(n)arenas, metal complex compounds, benzimidazolones, azines, thiazines or oxazines listed in the Color Index as Pigments, Solvent Dyes, Basic Dyes or Acid Dyes, fatty acid metal salt of aluminum or magnesium, unsaturated carboxylic acid or derivative thereof, unsaturated epoxy monomer or silane monomer, maleic anhydride, monoazo metal compound, alkyl acrylate monomers, alkyl methacrylate monomers, calixarene compound, phenolic OH of said calixarene compounds metallized with alkali metal or alkaline earth metal, rhodamine, xanthene-type dye, polytetrafluoroethylene, alkylene, arylene, aryleneialkylene, alkylenediarylene, oxydialkylene or oxydiarylene, polyacrylic and polymethacrylic acid compound, organic titanate, quaternary phosphonium trihalozincate salts, organic silicone complex compound, dicarboxylic acid compound, cyclic polyether or non-cyclic polyether and cyclodextrin, complex salt compound of the amine derivative, ditertbutylsalicyclic acid, potassium tetaphenylborate, potassium bis borate, sulfonamides and metal salts, cycloalkyl, alumina particles treated with silane coupling from group consisting of dimethyl silicone compound, azo dye, phthalic ester, quaternary ammonium salt, carbazole, diammonium and triammonium, hydrophobic silica and iron oxide, phenyl, substituted phenyl, naphthyl, substituted naphthyl, thienyl, alkenyl and alkylammonium complex salt compound, sodium dioctylsulfosuccinate and sodium benzoate, zinc complex compound, mica, monoalkyl and dialkyl tin oxides and urthene compound, metal complex of salicyclic acid compound, oxazolidinones, piperazines or perfluorinated alkane, fatty acid amides, oleophobic fluorochemical surfactants, lecigran MT, nigrosine, fumed silca, carbon black, para-trifluoromethyl benzoic acid and ortho-fluoro benzoic acid, poly(styrene-co-vinylpyridinium toluene sulfonate), methyl or butyltriphenyl phosphonium-p-toluene sulfonate, complex aromatic amines, triphenylamine dyes and azine dyes, alkyldimethylbenzylammonium salts, a charge director is selected from the group consisting of lecithin, basic barium petronate and calcium petronate, sulfonate compounds, isopropylamine salt of dodecylbenzensulfonic acid or diethylammonium chloride and isopropylamine dodecylbenzenesulfonate, quaternized ammonium AB diblock copolymer, polyacrylic acid, silicone carbide, PTFE particles, aluminum oxide, cross linked polymethacrylicate resin, silica acrylate complex, poly acrylic acid and amorphous silica.

10. An air filtration filter according to claim 9 in which the material contains 0.1 to 50 percent by weight based on weight of the material of charge control agent.

11. An air filtration media according to claim 10 in which the material contains from 0.2 to 5 percent by weight of charge control agents.
